(19) United States
(12) Patent Application Publication
(10) Pub. No.: US 2018/0326765 A1
(43) Pub. Date: Nov. 15, 2018

(54) MEDIA REPLACEMENT PROCESS FOR THERMAL PRINTERS

(71) Applicant: Datamax-O'Neil Corporation, Orlando, FL (US)

(72) Inventors: Yinting Ji, SuZhou (CN); Pu Liang, SuZhou (CN)

(21) Appl. No.: 15/961,224

(22) Filed: Apr. 24, 2018

(30) Foreign Application Priority Data
May 12, 2017 (CN) 201710333936.X

(51) Int. Cl. B41J 17/32; B65H 16/04; B65H 19/12

(52) U.S. Cl. CPC B41J 17/32; B65H 19/123; B65H 16/04

(57) ABSTRACT

The present invention embraces a method and apparatus for improving ribbon replacement for thermal printers. The present invention also applies to replacement of other media in associated printers. The improvement is achieved based a ribbon adapter or media adapter that is designed for two conditions: 1) catch condition for printing, and 2) release condition for replacing the media in the printer. By a single click or press of a button, a user can switch between the two conditions. The printing operation occurs during the catch condition. The catch condition ensures that there is no or little relative movement between media core and media adapter. The media adapter can also support different diameter media cores. The release condition is implemented when the user replaces media. The release condition can provide a relatively easy replacement of a media without a significant force or pressure.

### CROSS-REFERENCE TO RELATED APPLICATION

The present application claims the benefit of Chinese Patent Application for Invention No. 201710333936.X for a Media Replacement Process for Thermal Printers filed on May 12, 2017, which is hereby incorporated by reference in its entirety.

### FIELD OF THE INVENTION

The present invention relates to an apparatus and method to improve ribbon replacement process in thermal printers.

### BACKGROUND

Generally speaking the current ribbon adapter uses a part for catching the ribbon core. This part can be metal or can be plastic. This configuration has two concerns. First, when a user replaces the ribbon in the printer, the user may need to use substantial force to remove the ribbon core from ribbon adapter and install a new ribbon core. The user not only needs to overcome the ribbon's own gravity, but also overcome the sliding friction between the ribbon core and ribbon adapter, because of the interference fit between the core and adapter. The configuration is not very efficient and not very ergonomics-friendly.

Second, since the ribbon core must slide onto and out of ribbon adapter numerous times, this motion causes reciprocating sliding wear, which will deteriorate interface between the catch to the ribbon core. Hence, this wear can affect the synchronism between the ribbon core and ribbon adapter. The result is a reduction in the printing quality. The printer has a tolerance to adjust for this issue, but if the deterioration exceeds the tolerance, poor printing quality will eventually result.

Therefore, a need exists for to improve ribbon replacement process in thermal printers.

### SUMMARY

Accordingly, in one aspect, the present invention embraces a method and apparatus for improving ribbon replacement for thermal printers. The present invention also applies to replacement of other media in associated printers. The improvement can be achieved based a ribbon adapter or a media adapter designed for two conditions: 1) catch condition for printing, and 2) release condition for replacing the media in the printer. By a single click or press of a button, a user can switch between the two conditions. The printing operation occurs during the catch condition. The catch condition ensures that there is no or little relative movement between media core and media adapter.

In an exemplary embodiment, a method can include the steps of: activating a release condition with a press of a button on a media adapter of a printer; removing a media core from the media adapter; loading a spool of media on the media adapter; activating a catch condition with another press of the button on the media adapter; and printing utilizing the spool of the media. When the spool of the media is empty or depleted of media, the above steps are repeated. The media adapter comprises a combination of wedge and spring structures.

Each press of the button of the media adapter causes the media adapter to switch from the catch condition to the release condition, or vice-versa. The media adapter further includes a push rod, a catcher, and a spring, and the catcher comprises a plurality of claws. The activation of the release condition causes the plurality of claws of the catcher to retract inward. The activation of the catch condition causes the plurality of claws of the catcher to push outward.

Each press of the button on the media adapter causes the forward or backward movement of the button and the push rod (Direction B and A). Each press of the button on the media adapter causes a clockwise or counterclockwise rotation of the push rod based on a wedge-shaped force between the button and the push rod. Also, the press of the button can comprise a single click of the button. On a thermal printer, a media takeup spindle can be the media adapter. Also, on a thermal printer, a media supply spindle can be the media adapter.

In another exemplary embodiment, a media adapter can comprise: a cylindrical button with one or more force points at one end of the cylindrical button; a cylindrical push rod with a plurality of wedge-shaped edges at one end of the cylindrical push rod and a pointed shaped at another end of the cylindrical push rod; a cylindrical catcher comprising a plurality of claws; and a spring positioned inside of the cylindrical catcher. A press of the cylindrical button causes the plurality of claws of the cylindrical catcher to push outward or to retract inward. The one or more force points at one end of the cylindrical button are positioned to interface with the plurality of wedge-shaped edges at one end of the cylindrical push rod. The pointed shaped at the other end of the cylindrical push rod is positioned inside the cylindrical catcher and the spring.

When the plurality of claws of the cylindrical catcher are pushed outward, the plurality of claws catch a surface of a media core to secure a position of the media adapter relative to the media core. When the plurality of claws of the cylindrical catcher are retracted inward, the plurality of claws release a surface of a media core to allow the media core to be removed from the media adapter. Each press of the cylindrical button causes a clockwise or counterclockwise rotation of the push rod based on a wedge-shaped force between the one or more force points at one end of the cylindrical button and plurality of wedge-shaped edges at one end of the cylindrical push rod. Each press of the button on the media adapter causes the forward or backward movement of the button and the push rod (Direction B and A). Each press of the cylindrical button causes the media adapter to switch from a catch condition where the plurality of claws are pushed outward, to a release condition where the plurality of claws are retracted inward, or vice-versa.

In yet another exemplary embodiment, a method can comprise the steps of: activating a plurality of claws of a media adapter to secure a media core installed on the media adapter; printing using media on the media core; deactivating the plurality of claws of the media adapter to allow removal of the media core; inserting another media core; and repeating the aforementioned steps. The media adapter can comprise a combination of wedge and spring structures

The activation and deactivation of the plurality of claws can be initiated by a press of a button located on the media adapter. Each press of the button of the media adapter causes the media adapter to switch from a catch condition to a release condition, or vice-versa. The media adapter can further comprise a push rod, a catcher, and a spring, wherein the catcher comprises the plurality of claws. Each press of the button on the media adapter can cause a clockwise or counterclockwise rotation of the push rod based on a wedge-shaped force between the button and the push rod. Each press of the button on the media adapter causes the forward or backward movement of the button and the push rod (Direction B and A).

In yet another exemplary embodiment a printer can comprise: a cylindrical button, which is incorporated in a media adapter of the printer, and includes one or more force points at one end of the cylindrical button. A press of the cylindrical button causes a plurality of claws of a cylindrical catcher to push outward or to retract inward. The one or more force points at one end of the cylindrical button are positioned to interface with a plurality of wedge-shaped edges at one end of a cylindrical push rod.

Each press of the cylindrical button causes a forward or backward movement of the cylindrical button and the cylindrical push rod and causes a clockwise or counterclockwise rotation of the cylindrical push rod based on a wedge-shaped force between the one or more force points at one end of the cylindrical button and plurality of wedge-shaped edges at one end of the cylindrical push rod.

Each press of the cylindrical button causes the media adapter to switch from a catch condition where the plurality of claws are pushed outward, to a release condition where the plurality of claws are retracted inward, or vice-versa. When the plurality of claws of the cylindrical catcher are pushed outward, the plurality of claws catch a surface of a media core to secure a position of the media adapter relative to the media core.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1A illustrates an internal view of a PM43 thermal printer.

FIG. 1B illustrates an embodiment of a cross sectional view of a ribbon adapter and a ribbon core of a PM43 thermal printer.

FIG. 2A illustrates an exemplary embodiment of a ribbon adapter and its components.

FIG. 2B illustrates an exemplary embodiment of a ribbon core installed in a ribbon adapter.

FIG. 2C illustrates an exemplary embodiment of force points and wedge-shaped edges in a ribbon adapter.

FIG. 3 illustrates an exemplary flowchart of a method to replace a ribbon in a printer via a release and catch procedure.

FIG. 4 illustrates an exemplary embodiment of a ribbon adapter and ribbon core in a release condition.

FIG. 5A illustrates an exemplary embodiment of a ribbon adapter in switch process 1 that activates a “catch” conditions with a button press.

FIG. 5B illustrates an exemplary embodiment of wedge-shaped force as utilized in a ribbon adapter.

FIG. 5C illustrates an exemplary embodiment of inside features of a pipe as utilized in a ribbon adapter.

FIG. 5D illustrates an exemplary embodiment of operational aspects of the inside features of a pipe and a button as utilized in a ribbon adapter.

FIG. 5E illustrates an exemplary embodiment of additional operational aspects of the inside features of a pipe and a push rod as utilized in a ribbon adapter.

FIG. 5F illustrates an exemplary embodiment of additional operational aspects of the inside features of a pipe and a push rod as utilized in a ribbon adapter

FIG. 6 illustrates an exemplary embodiment of a ribbon adapter and ribbon core in a “catch” condition.

FIG. 7 illustrates an exemplary embodiment of a ribbon adapter in switch process 2 that activates a “release” condition from a “catch condition” with a button press.

### DETAILED DESCRIPTION

The present invention, as described in this Specification, is based on applications supporting thermal transfer ribbon. However, the present invention is not limited to applications supporting thermal transfer ribbon, but may also be applied to other media including, but not limited to, paper, labels, and tickets. In other words, the present invention applies to replacement of other media in associated printers.

The present invention embraces a method and apparatus for improving ribbon replacement for thermal printers. The improvement is achieved based a ribbon adapter designed for two conditions: 1) catch condition for printing, and 2) release condition for replacing the ribbon in the printer. By a single click or press of a button, a user can switch between the two conditions. The printing operation occurs during the catch condition. The catch condition ensures that there is no or little relative movement between ribbon core and ribbon adapter. The ribbon adapter can also support different diameter ribbon cores. The release condition is implemented when the user replaces the ribbon. The release condition may make it relatively easy to replace the ribbon without a significant force or pressure. Hence, in the present invention, each press of the button of the ribbon adapter causes the ribbon adapter to switch from the catch condition to the release condition, or vice-versa.

A thermal printer can have two ribbon adapters, i.e., one for a ribbon supply (or ribbon supply spindle) and another for a ribbon takeup (or ribbon takeup spindle). The ribbon adapter comprises a combination of wedge and spring structures.

When used as a ribbon supply, the ribbon adapter holds a spool of ribbon that is wrapped around a ribbon core. The ribbon adapter is designed to toggle between the two conditions by pressing a button: Catch condition and Release condition. The ribbon adapter is designed in such a way that when the button is pressed, the claws of a catcher component of the ribbon adapter are pushes outward to firmly hold the ribbon core. The catch condition creates an interference fit between the ribbon adapter and the ribbon core.

When the button is pressed again, the ribbon adapter changes to a release condition, where the push rod moves to original position by the spring so that claws are retracted in to the adapter, thus, creating a clearance fit to make it easier to remove the ribbon core.

In a current printer design, e.g., a Honeywell PM43 thermal printer, the ribbon core and the ribbon adapter are always an interference fit. This means there are always pressures between the ribbon core and ribbon adapter. In the present invention, with a release condition, the ribbon core and ribbon adapter have minimal contact with each other, so the sliding wear condition is minimized. Sliding wear occurs when the two parts have relative motion and when they contact each other creating pressure between the two parts.

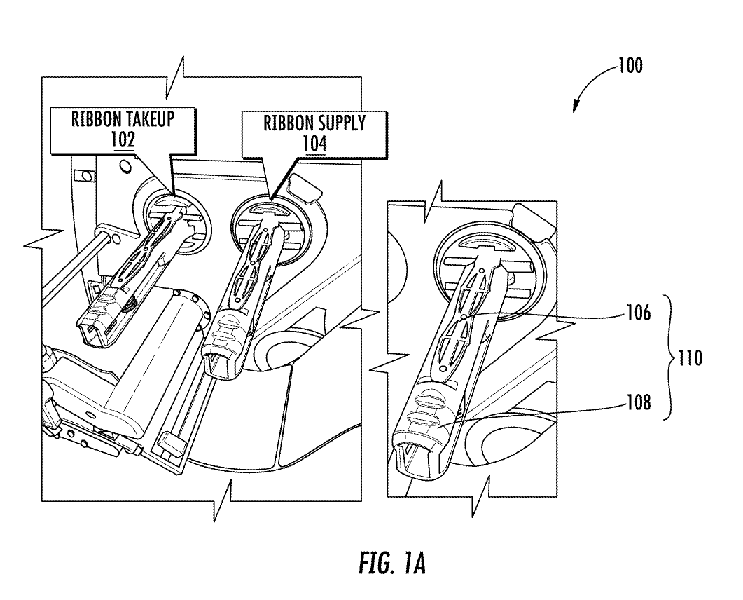

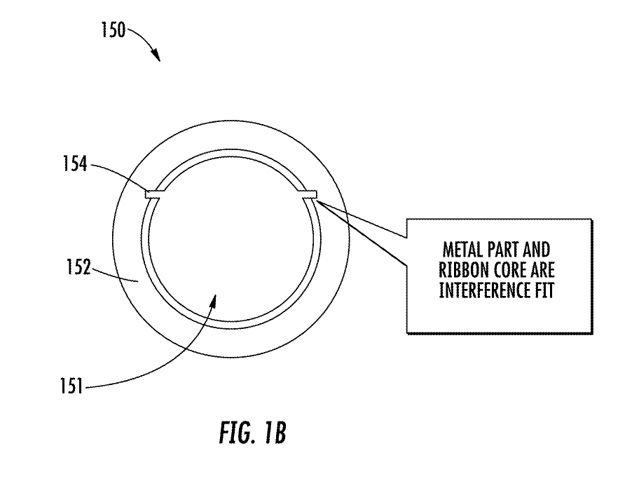

FIG. 1A illustrates embodiment 100 of an internal view of a Honeywell PM43 thermal printer and the basic components in ribbon adapter 110. Specifically, ribbon adapter 110 comprises a metal part 106 and a plastic part 108. Two ribbon adapters 110 are utilized in a Honeywell PM43 thermal printer. One is utilized as ribbon takeup 102 and the other is utilized as ribbon supply 104. A ribbon core with a spool of ribbon is installed on the ribbon supply 104. After being used in the printing process, the used ribbon is spooled on a ribbon core installed on the ribbon takeup 102.

FIG. 1B illustrates embodiment 150 of a cross sectional view of a ribbon adapter 151 and a ribbon core 152. Ribbon adapter 151 comprises metal of ribbon adapter 154 that provides an interference fit between ribbon adapter 151 and ribbon core 152. With this interference fit, ribbon core 152 can be securely positioned with ribbon adapter 151. That is, there is essentially no movement between ribbon core 152 and ribbon adapter 151.

Since the ribbon core 152 is installed on ribbon adapter 151 multiple times, reciprocating sliding wear can result for both ribbon core 152 and ribbon adapter 151. This wear condition can cause an imperfect catch to ribbon core 152. Hence, the imperfect catch can affect the synchronism between the ribbon core 152 and the ribbon adapter 151. The printing quality can be negatively impacted. For example, while rotating at the same time, a wear condition can allow ribbon adapter 151 to rotate 360 degrees, but can only allow ribbon core 152 to rotate 350 degrees. The printer may only have a small tolerance (e.g., 2 degrees) to accommodate this issue so poor quality printing can result.

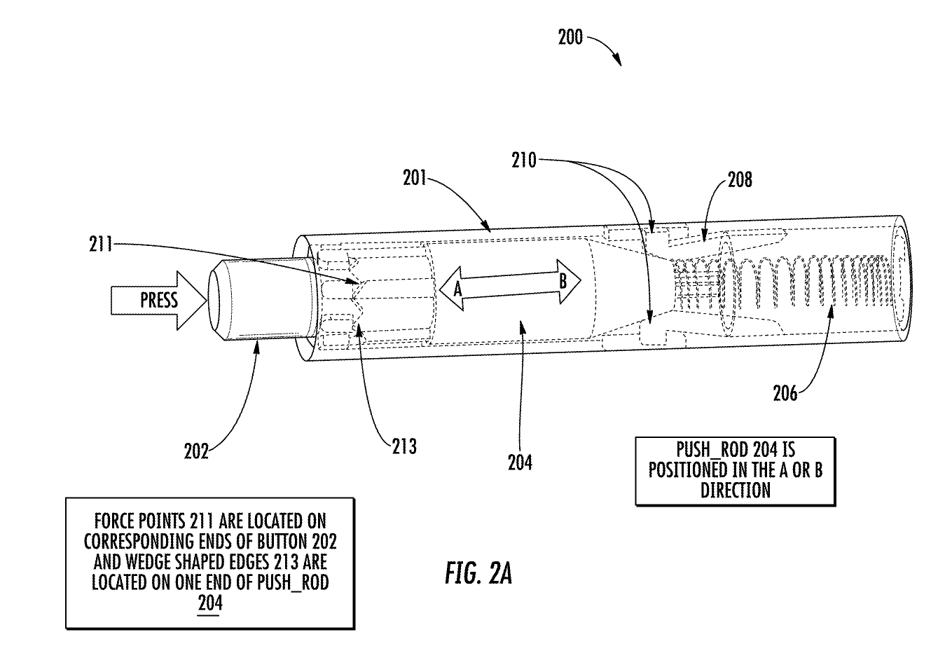

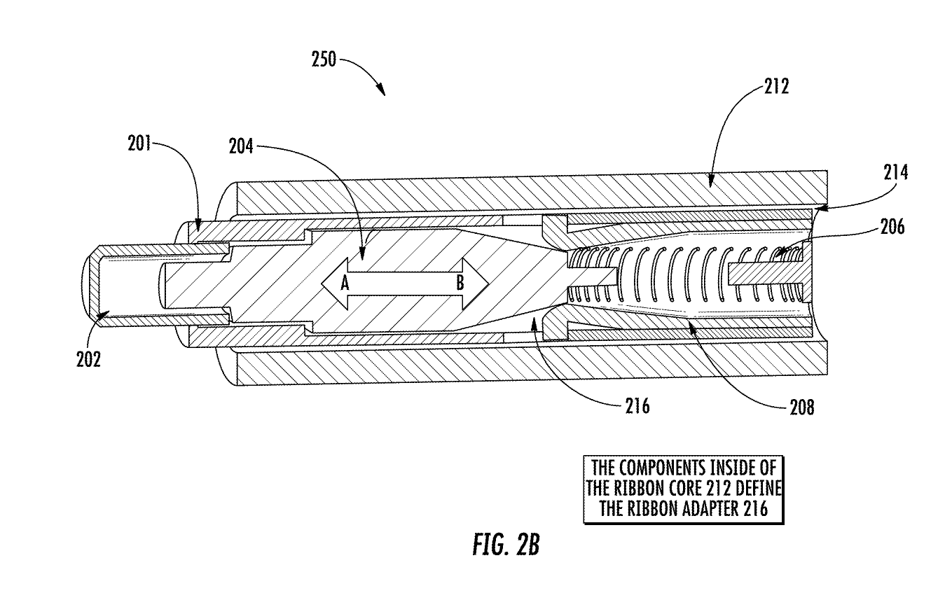

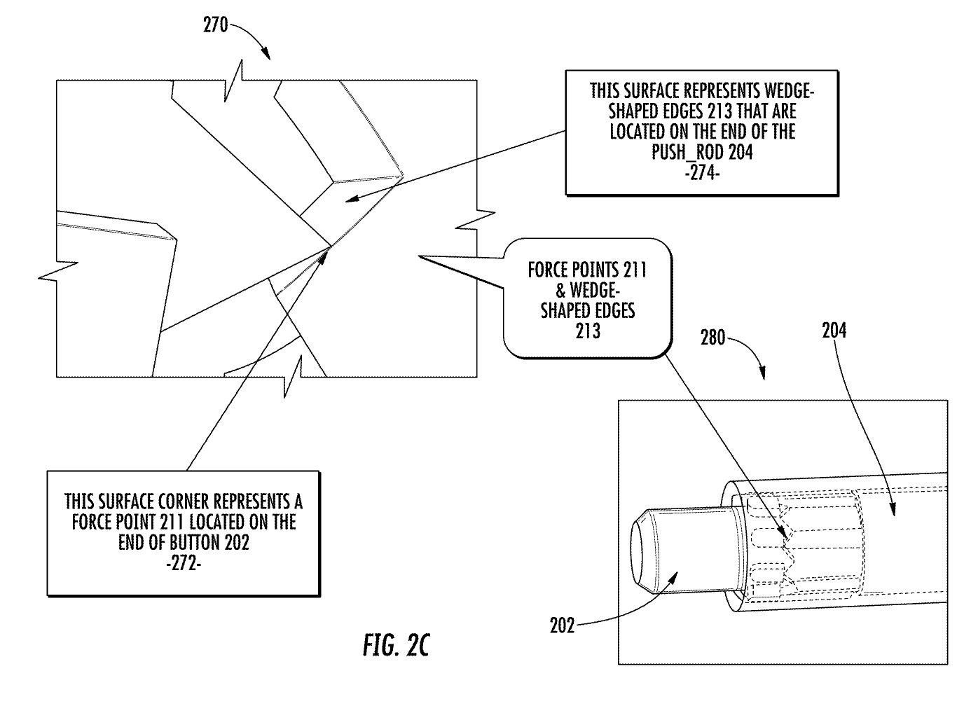

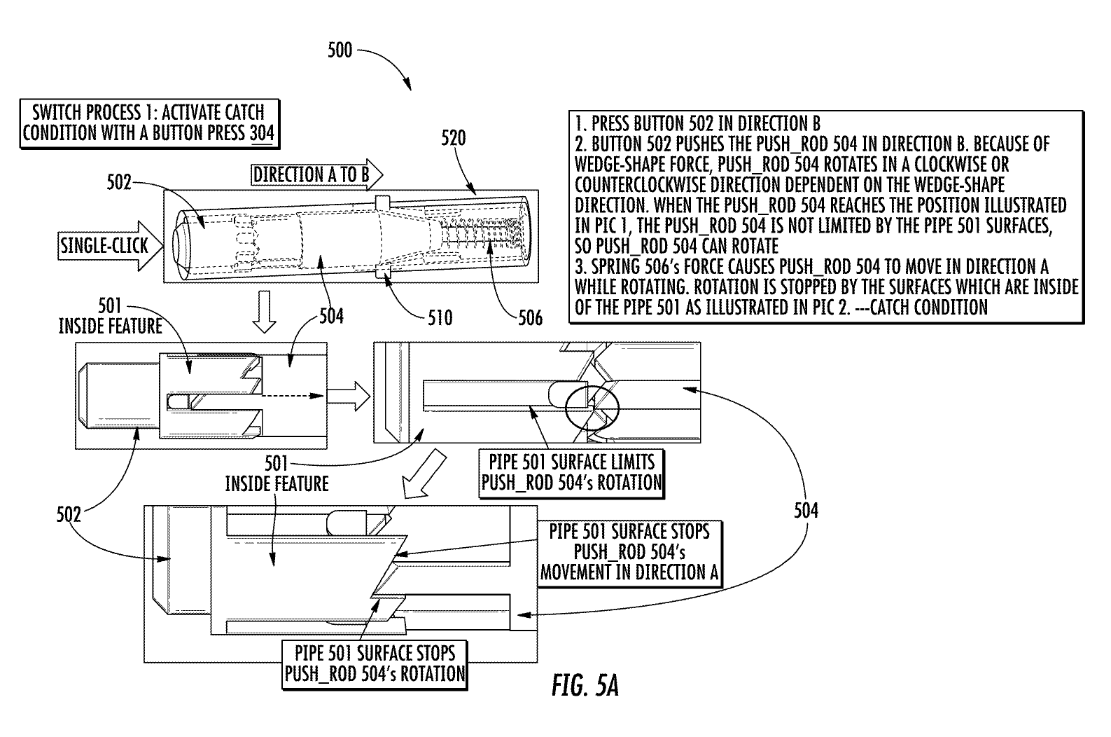

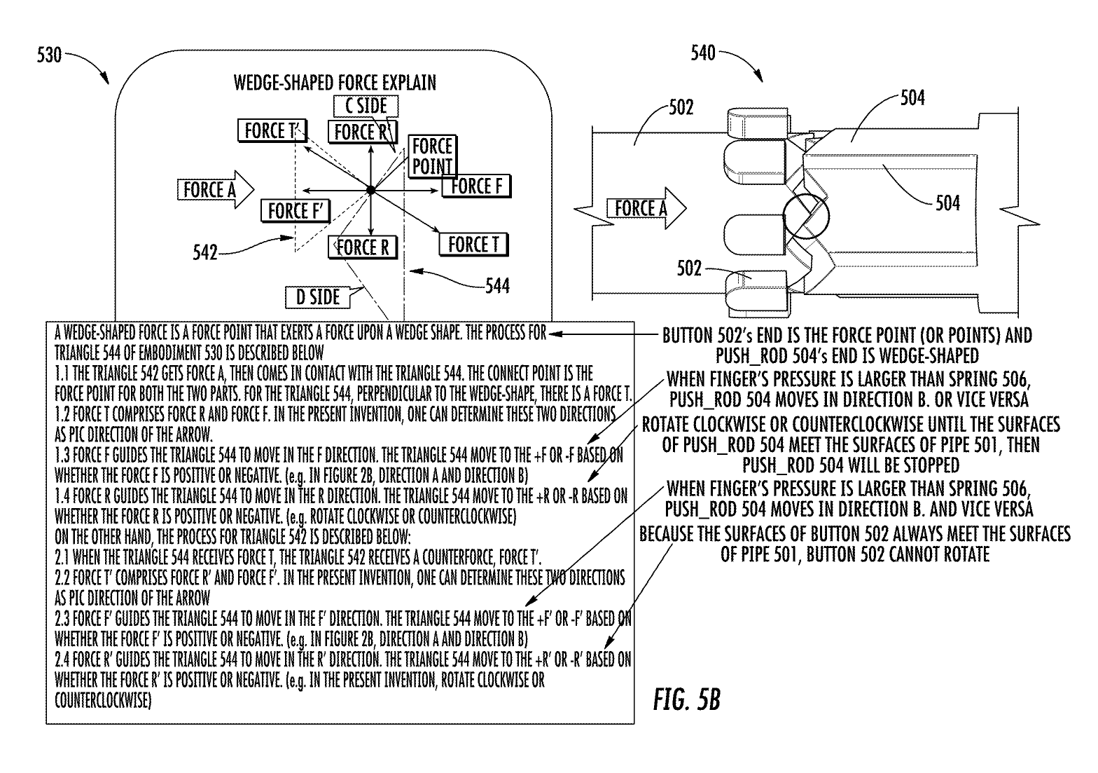

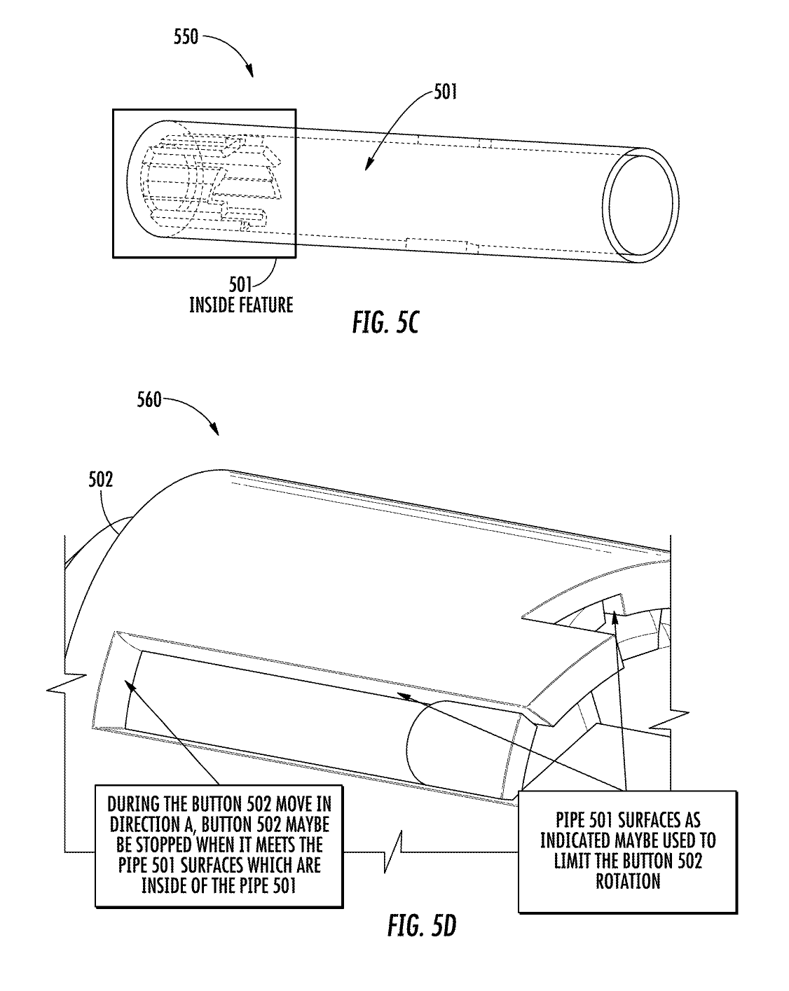

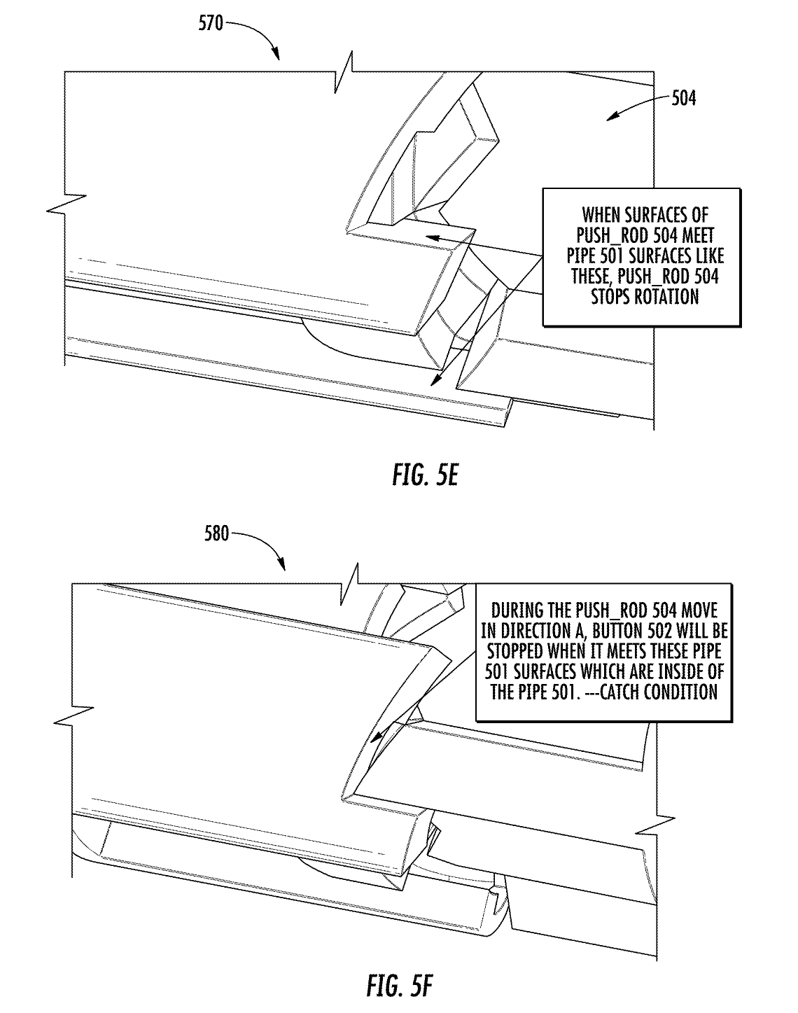

FIG. 2A illustrates an exemplary embodiment of a ribbon adapter 200 and its components. Ribbon adapter 200 can be a cylindrical component comprising pipe 201, button 202, PUSH_ROD 204, spring 206, catcher 208, and claws 210. FIG. 2A includes a view of pipe 201 including other components of ribbon adapter 200. Also illustrated is a view of one end of catcher 208. With a press of button 202, PUSH_ROD 204 is forced into catcher 208, as illustrated by a view of the one end of catcher 208. PUSH_ROD 204 receives a counter force from spring 206, which is positioned inside catcher 208. Depending on the condition status, PUSH_ROD 204 can be positioned in the A direction or B direction. As illustrated pipe 201, button 202 PUSH_ROD 204, spring 206, and catcher 208 are cylindrical components. PUSH_ROD 204, spring 206, catcher 208, and claws 210 are located inside of pipe 201. Button 202 comprises plurality of force points 211 at one end of button 202. PUSH_ROD 204 comprises a plurality of wedge-shaped edges 213 at one end of the PUSH_ROD 204 and a pointed shape at the other end of PUSH_ROD 204. Force points 211 are located on corresponding ends of button 202 and wedge-shaped edges 213 are located on one end of PUSH_ROD 204. In other words, when a press of button 202 generates a force between a corresponding end of button 202 and PUSH_ROD 204, the result is referred to as a wedge-shaped force. A wedge-shaped force includes force points 211 which are located on corresponding end of button and wedge-shaped edges which are at the end of the cylindrical PUSH_ROD 204. See additional details on a wedge-shaped force in FIG. 5B and its associated description.

Catcher 208 comprising a plurality of claws 210 depending on the application. The pointed shape at the other end of the PUSH_ROD 204 is positioned inside the catcher and the spring as illustrated in FIG. 2A.

FIG. 2B illustrates an exemplary embodiment 250 of a cross-sectional view of ribbon core 212 installed on a ribbon adapter 216 (also shown in a cross-sectional view). Also shown are cross-sectional-views of button 202, PUSH_ROD 204, spring 206 and catcher 208. As illustrated, ribbon adapter 216 is installed inside ribbon core 212. Both components can be cylindrical components. The space between the outer edge of the ribbon adapter 216 (which is also the outer edge of pipe 201) and the inner edge of ribbon core 212 is gap 214. Depending on the condition status, gap 214 can be an interference fit (catch condition) or a clearance fit (release condition). As noted in FIG. 2B, the components inside of the ribbon core 212 define the ribbon adapter 216. Also, the components in the ribbon adapter 216 are equivalent to the components in ribbon adapter 200 of FIG. 2A.

FIG. 2C illustrates exemplary embodiments 270 and 280 of force points 211 and wedge-shaped edges 213 of ribbon adapter 200 as shown on FIG. 2A. Embodiment 270 shows close-up views of the locations of force points 211 and wedge-shaped edges 213. Arrow 272 shows a shaped corner representing a force point 211 that is located on the end of button 202. Arrow 274 shows a surface representing wedge-shaped edges 213 that are located on the end of PUSH_ROD 204. Embodiment 280 shows the locations of force points 211 and wedge-shaped edges 213 on ribbon adapter 200. Force points 211 are located at the end of button 202, and wedge-shaped edges 213 are located at the end of PUSH_ROD 204.

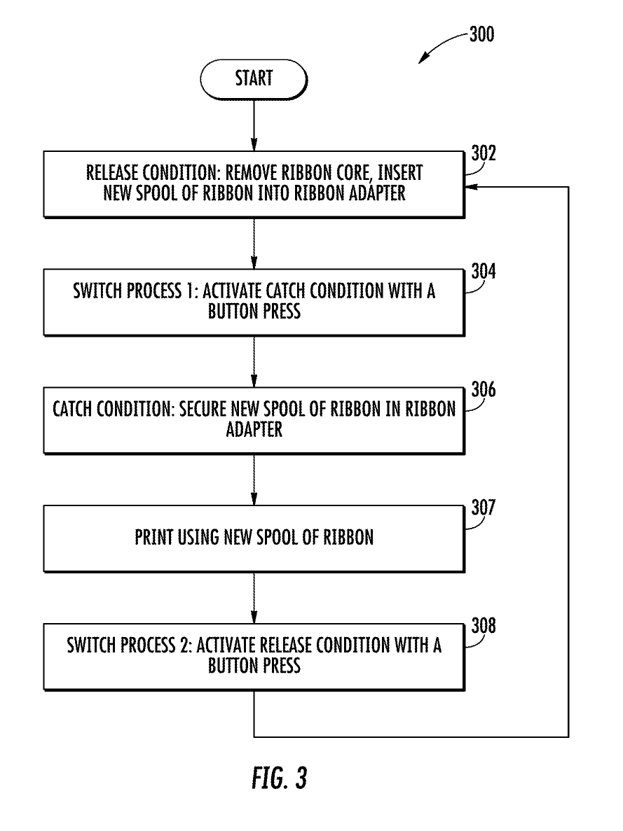

FIG. 3 illustrates an exemplary flowchart 300 of a method to replace a ribbon in a printer via a release and catch procedure. The method comprises the steps described below. In these steps, references are made relative to the components of FIGS. 2A and 2B.

Release condition: Remove ribbon core 212. Insert or load a new spool of ribbon on ribbon core 212 onto ribbon adapter 216. Ribbon adapter 216 can be ribbon supply 104 (step 302)

Switch Process 1: In order to secure the ribbon core 212 in the ribbon adapter 216, activate catch condition with a press on button 202. (step 304)

Catch condition: Secure a new spool of ribbon on ribbon core 212 in ribbon adapter 216. (step 306)

Print utilizing the new spool of ribbon on ribbon core 212. (step 307)

Switch process 2: When the spool of ribbon is empty or depleted of ribbon, activate release condition with a press of button 202. (step 308)

Repeat step 302-307 to replace the ribbon core 212 and print.

The ribbon adapter 216 can be used as a ribbon takeup 102 to cycle between a release condition and a catch.

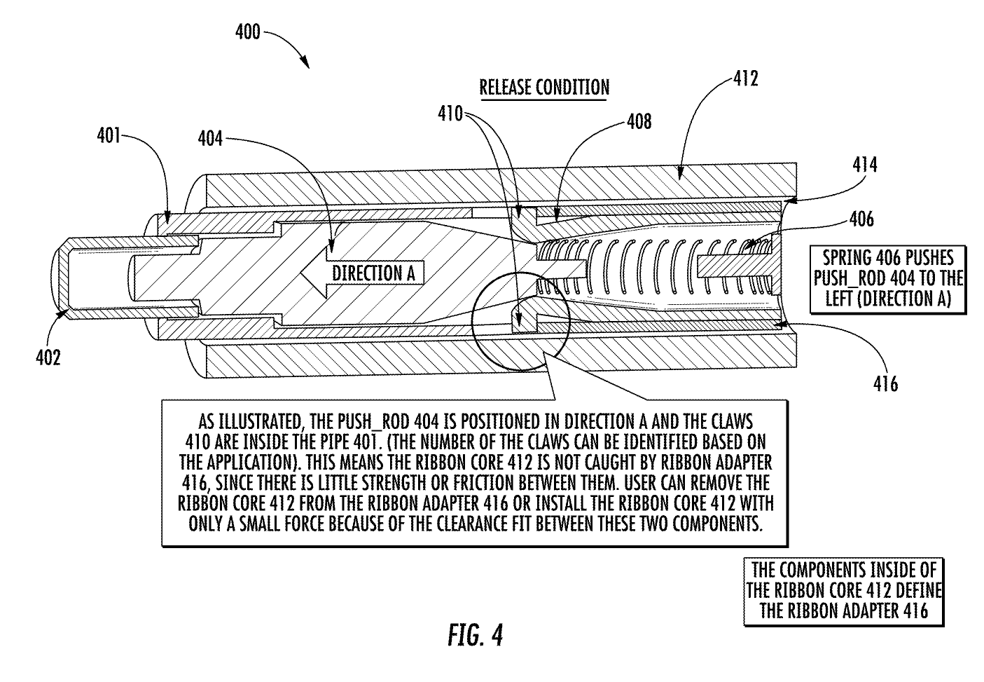

FIG. 4 illustrates an exemplary embodiment 400 of cross-sectional views of a ribbon adapter 416 and ribbon core 412 in release condition. Also shown are cross-sectional-views of button 402, PUSH_ROD 404, spring 406, catcher 408, and claws 410. The components inside of the Ribbon Core 412 define the Ribbon Adapter 416. These components include button 402, PUSH_ROD 404, spring 406, catcher 408, and claws 410. The space between the outer edge of the ribbon adapter 416 (which is also the outer edge of pipe 401) and the inner edge of ribbon core 412 is gap 414 (clearance fit).

As illustrated in FIG. 4, the PUSH_ROD 404 is positioned in the direction A, and the Claws 410 are positioned inside the pipe 401. (The number of the claws can be identified based on the application). This means the ribbon core 412 is not caught by ribbon adapter 416 and there is little strength or friction between them. As illustrated, gap 414 has a clearance fit indicating there is adequate space for ribbon adapter 416 to slide in or out of ribbon core 412. User can remove the ribbon core 412 from the ribbon adapter 416 or install the ribbon core 412 with only a little strength or effort because of the clearance fit between these two components. There is little sliding wear between ribbon adapter 416 and ribbon core 412. Thus, users can be conveniently and easily replace the ribbon core 412.

In summary, when claws 410 of catcher 408 are retracted inward, claws 410 release the surface of ribbon core 412 to allow the ribbon core 412 to be removed from the ribbon adapter 416 with little sliding friction.

FIG. 5A illustrates an exemplary embodiment 500 of a ribbon adapter 520 in switch process 1 that activates a “catch” condition from a “release” condition with a button press. Ribbon adapter 520 includes pipe 501, button 502, PUSH_ROD 504, spring 506, and claws 510. Several of these elements are shown in FIG. 5A.

The steps of switch process 1 include: 1) Press Button 502 in Direction B. 2) Button 502 pushes the PUSH_ROD 504 in Direction B. Because of wedge-shape force, PUSH_ROD 504 rotates in a clockwise or counterclockwise direction dependent on the wedge-shaped force between the button 502 and the PUSH_ROD 504. When the PUSH_ROD 504 reaches the position illustrated in pic 1, the PUSH_ROD 504 is not limited by the pipe 501 surfaces, so PUSH_ROD 504 can rotate. 3) Spring 506's force causes PUSH_ROD 504 to move in Direction A while rotating. Rotation is stopped by the surfaces which are inside of the pipe 501 as illustrated in pic 2—catch condition.

FIG. 5B illustrates an exemplary embodiment 530 and embodiment 540 of wedge-shaped force as utilized in a ribbon adapter. As illustrated in exemplary embodiment 530, a wedge-shaped force is a force point that exerts a force upon a wedge-shape. The process for triangle 544 of exemplary embodiment 530 is described below:

1.1 The triangle 542 gets Force A, then comes in contact with the triangle 544. The connect point is the force point for both the two parts. For the triangle 544, perpendicular to the wedge-shape, there is a Force T. Per embodiment 540, button 502's end is the force point (or points) and Push Rod 504's end is wedge-shaped.

1.2 Force T comprises Force R and Force F. In the present invention, one can determine these two directions as pic direction of the arrow.

1.3 Force F guides the triangle 544 to move in the F direction. The triangle 544 moves to the +F or −F based on whether the Force F is positive or negative (e.g. In FIG. 2B, direction A and direction B). Per embodiment 540, when the pressure, applied by a finger to button 502, is larger than pressure provided by spring 506, PUSH_ROD 504 moves in direction B. Or vice-versa.

1.4 Force R guides the triangle 544 to move in the R direction. The triangle 544 move to the +R or −R based on whether the Force R is positive or negative. (e.g. rotate clockwise or counterclockwise) Per embodiment 540, rotate clockwise or counterclockwise until the surfaces of PUSH_ROD 504 meet the surfaces of pipe 501, then PUSH_ROD 504 will be stopped.

On the other hand, the process for triangle 542 is described below:

2.1 When the triangle 544 receives Force T, the triangle 542 receives a counterforce, Force T′.

2.2 Force T′ comprises Force R′ and Force F′. In the present invention, one can determine these two directions as pic direction of the arrow.

2.3 Force F′ guides the triangle 544 to move in the F′ direction. The triangle 544 moves to the +F′ or −F′ based on whether the Force F′ is positive or negative (e.g. in FIG. 2B, direction A and direction B). Per embodiment 540, when the pressure, applied by a finger to button 502, is larger than pressure provided by spring 506, PUSH_ROD 504 moves in direction B. Or vice-versa.

2.4 Force R′ guides the triangle 544 to move in the R′ direction. The triangle 544 moves to the +R′ or −R′ based on whether the Force R′ is positive or negative (e.g. in the present invention, rotate clockwise or counterclockwise). Per embodiment 540, because the surfaces of button 502 always meet the surfaces of pipe 501, button 502 cannot rotate.

Embodiment 540 illustrates the wedge-shaped action between button 502 and PUSH_ROD 504. Each press of button 502 on the ribbon adapter 520 causes a forward or backward movement of button 502 and PUSH_ROD 504 (Direction B and A). Also, when there is a press of button 502, causing Force A to be applied to PUSH_ROD 504, PUSH_ROD 504 rotates clockwise or counterclockwise because of the wedge-shaped power. In other words, each press of the button 502 on the ribbon adapter 520 causes a clockwise or counterclockwise rotation based on a wedge-shaped force between the button and the push rod. Each press of the cylindrical button also causes the forward or backward movement of button 202 and PUSH_ROD 504 (Direction B and A). The wedge-shaped force is a force point that exerts a force upon a wedge-shape. Button 552's end is the force point (or points) and PUSH_ROD 504's end comprises wedge-shapes. In other words, the one or more force points at one end of the cylindrical button are positioned to interface with the plurality of wedge-shaped edges at one end of the cylindrical PUSH_ROD 504.

FIG. 5C illustrates an exemplary embodiment 550 of inside features of a pipe 501 as utilized in a ribbon adapter 520. FIG. 5D illustrates an exemplary embodiment 560 of aspects of the inside features of a pipe 501 including button 502 as utilized in a ribbon adapter 520. When the button 502 moves in direction A, button 502 maybe be stopped when it meets the pipe 501 surfaces which are inside of the pipe 501. FIG. 5E illustrates an exemplary embodiment 570 of additional operational aspects of the inside features of a pipe 501 and PUSH_ROD 504 as utilized in a ribbon adapter 520. FIG. 5F illustrates an exemplary embodiment 580 of additional operational aspects of the inside features of a pipe 501 and PUSH_ROD 504 as utilized in a ribbon adapter 520.

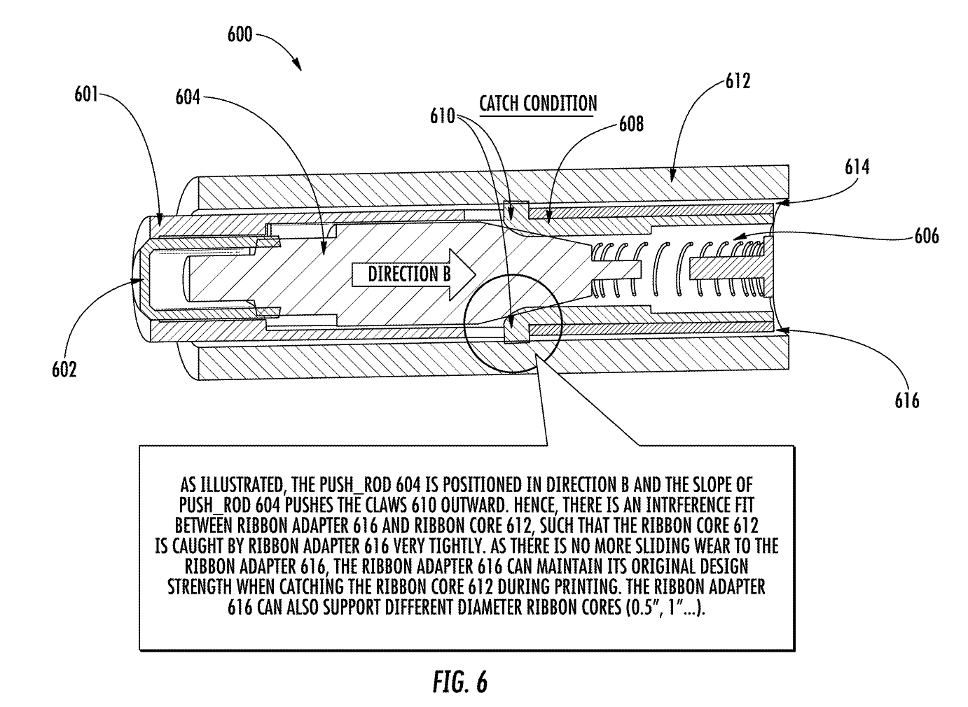

FIG. 6 illustrates an exemplary embodiment 600 of cross-sectional views of a ribbon adapter 616 and ribbon core 612 in a catch condition. Also shown are cross-sectional-views of button 602, PUSH_ROD 604, spring 606, catcher 608, and claws 610. The components inside of the ribbon core 612 define the ribbon adapter 616. These components include button 602, PUSH_ROD 604, spring 606, catcher 608, and claws 610. The space between the outer edge of the ribbon adapter 416 (which is also the outer edge of pipe 601) and the inner edge of ribbon core 612 is gap 614.

As illustrated, the PUSH_ROD 604 is positioned in direction B and the slope of PUSH_ROD 604 pushes the claws 610 outward. This action causes an interference fit between ribbon adapter 616 and ribbon core 612, such that the ribbon core 612 is caught by ribbon adapter 616 very tightly. As there is no more sliding wear to the ribbon adapter 616, the ribbon adapter 616 can maintain its original design strength when catching the ribbon core 612 during printing. The ribbon adapter 616 can also support different diameter Ribbon Cores (0.5″, 1″ . . . ).

In summary, when claws 610 of catcher 608 are pushed outward, claws 610 catch a surface of a ribbon core 612 to secure the position of the ribbon adapter 616 relative to ribbon core 612.

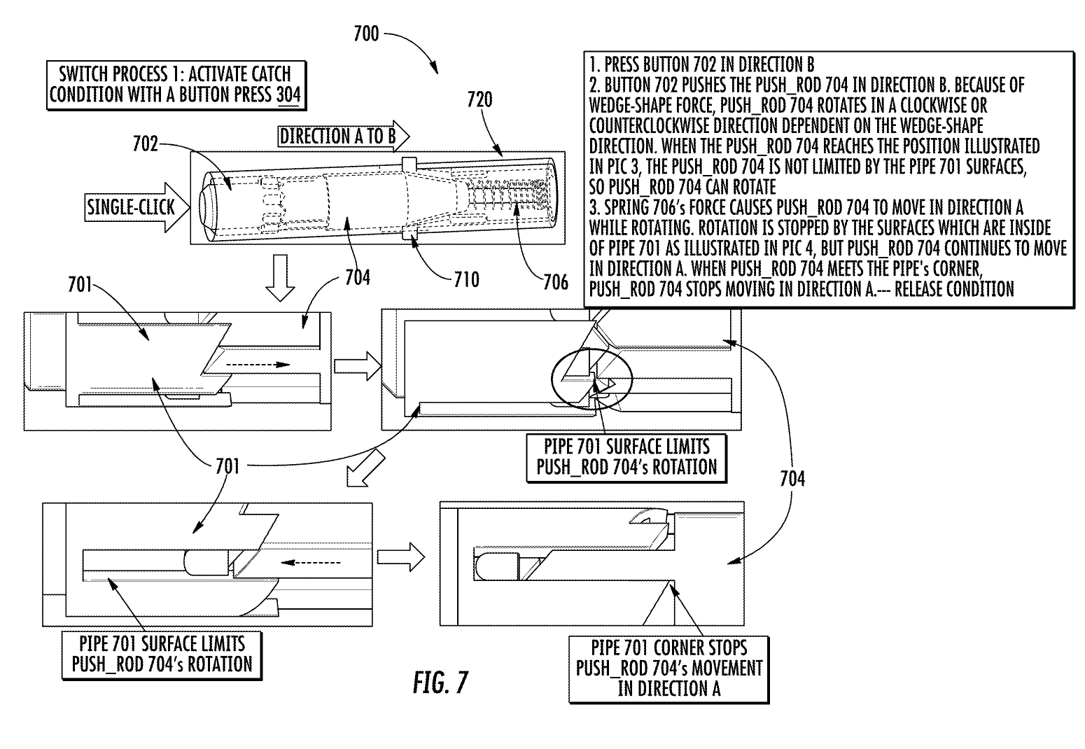

FIG. 7 illustrates an exemplary embodiment 700 of a ribbon adapter 720 in switch process 2 that activates a “release condition from a “catch condition with a button press. Ribbon adapter 720 includes pipe 701, button 702, PUSH_ROD 704, spring 706, and claws 710. Several of these elements are shown in FIG. 7.

Switch process 2 can be implemented with the following steps: 1) Press Button 702 in Direction B. This action can be a single-click of button 702. 2) Button 702 pushes the PUSH_ROD 704 in Direction B. Because of wedge-shape force, PUSH_ROD 704 rotates in a clockwise or counterclockwise direction dependent on the wedge-shaped force between the button 702 and the PUSH_ROD 704. When the PUSH_ROD 704 reaches the position illustrated in pic 3, the PUSH_ROD 704 is not limited by of pipe 701 surfaces, so PUSH_ROD 704 can rotate. 3) Spring 706's force causes PUSH_ROD 704 to move in Direction A while rotating. Rotation is stopped by the surfaces which are inside of pipe 701 as illustrated in pic 4, but PUSH_ROD 704 continues to move in Direction A. When PUSH_ROD 704 meets the pipe's corner, PUSH_ROD 704 stops moving in Direction A as illustrated in pic 5—release condition.

Thermal transfer printing is a digital printing process by melting a coating of ribbon so that it stays glued to the material on which the print is applied. It contrasts with direct thermal printing where no ribbon is present in the process.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method, comprising steps of:
activating a release condition with a press of a button on a media adapter of a printer;
removing a media core from the media adapter;
loading a spool of media on the media adapter;
activating a catch condition with another press of the button on the media adapter; and
printing utilizing the spool of media,
wherein, the media adapter comprises a combination of wedge and spring structures.

2. The method as in claim 1, wherein, each press of the button of the media adapter causes the media adapter to switch from the catch condition to the release condition, or vice-versa.

3. The method as in claim 1, wherein, the media adapter further comprises a push rod, a catcher, and a spring, wherein the catcher comprises a plurality of claws.

4. The method as in claim 3, wherein, the activation of the release condition causes the plurality of claws of the catcher to retract inward.

5. The method as in claim 3, wherein, the activation of the catch condition causes the plurality of claws of the catcher to push outward.

6. The method as in claim 3, wherein, each press of the button on the media adapter causes a forward or backward movement of the button and the push rod and causes a clockwise or counterclockwise rotation of the push rod based on a wedge-shaped force between the button and the push rod.

7. The method as in claim 1, wherein, when the spool of media is depleted from media supply spindle, re-activate release condition.

8. The method as in claim 1, wherein, on a thermal printer, a media takeup spindle is the media adapter.

9. The method as in claim 1, wherein on a thermal printer, a media supply spindle is the media adapter.

10. A media adapter, comprising:
a cylindrical button with one or more force points at one end of the cylindrical button;
a cylindrical push rod with a plurality of wedge-shaped edges at one end of the cylindrical push rod and a pointed shaped at another end of the cylindrical push rod;
a cylindrical catcher comprising a plurality of claws; and
a spring positioned inside of the cylindrical catcher,
wherein, a press of the cylindrical button causes the plurality of claws of the cylindrical catcher to push outward or to retract inward.

11. The media adapter as in claim 10, wherein, the one or more force points at one end of the cylindrical button are positioned to interface with the plurality of wedge-shaped edges at one end of the cylindrical push rod.

12. The media adapter as in claim 10, wherein, the pointed shaped at the another end of the cylindrical push rod is positioned inside the cylindrical catcher and the spring.

13. The media adapter as in claim 10, wherein, when the plurality of claws of the cylindrical catcher are pushed outward, the plurality of claws catch a surface of a media core to secure a position of the media adapter relative to the media core.

14. The media adapter as in claim 10, wherein, when the plurality of claws of the cylindrical catcher are retracted inward, the plurality of claws release a surface of a media core to allow the media core to be removed from the media adapter.

15. The media adapter as in claim 10, wherein, each press of the cylindrical button causes a forward or backward movement of the cylindrical button and the cylindrical push rod and causes a clockwise or counterclockwise rotation of the cylindrical push rod based on a wedge-shaped force between the one or more force points at one end of the cylindrical button and plurality of wedge-shaped edges at one end of the cylindrical push rod.

16. The media adapter as in claim 10, wherein, each press of the cylindrical button causes the media adapter to switch from a catch condition where the plurality of claws are pushed outward, to a release condition where the plurality of claws are retracted inward, or vice-versa.

17. A printer comprising:
a cylindrical button, which is incorporated in a media adapter of the printer, comprises one or more force points at one end of the cylindrical button,
wherein, a press of the cylindrical button causes a plurality of claws of a cylindrical catcher to push outward or to retract inward, and
wherein, the one or more force points at one end of the cylindrical button are positioned to interface with a plurality of wedge-shaped edges at one end of a cylindrical push rod.

18. The printer as in claim 17, wherein, each press of the cylindrical button causes a forward or backward movement of the cylindrical button and the cylindrical push rod and causes a clockwise or counterclockwise rotation of the cylindrical push rod based on a wedge-shaped force between the one or more force points at one end of the cylindrical button and plurality of wedge-shaped edges at one end of the cylindrical push rod.

19. The printer as in claim 17, wherein, each press of the cylindrical button causes the media adapter to switch from a catch condition where the plurality of claws are pushed outward, to a release condition where the plurality of claws are retracted inward, or vice-versa.

20. The printer as in claim 19, wherein, when the plurality of claws of the cylindrical catcher are pushed outward, the plurality of claws catch a surface of a media core to secure a position of the media adapter relative to the media core.
